(19) United States
(12) Patent Application Publication
(10) Pub. No.: US 2019/0021347 A1
(43) Pub. Date: Jan. 24, 2019

(54) Mobile Meat Processing System And Related Methods And Devices

(71) Applicant: Wild Idea Buffalo Co. LLC., Rapid City, SD (US)

(72) Inventor: Dan O'Brien, Hermosa, SD (US)

(21) Appl. No.: 16/039,517

(22) Filed: Jul. 19, 2018

Related U.S. Application Data
(60) Provisional application No. 62/534,492, filed on Jul. 19, 2017.

(51) Int. Cl. A22B 7/00; A22B 5/06

(52) U.S. Cl. CPC A22B 7/004; A22B 5/06

(57) ABSTRACT

Disclosed herein is a mobile meat processing system having a mobile unit, an animal processing room, a refrigeration room, a track system disposed from a ceiling of the mobile unit, and an animal intake door coupled to a wall of the animal processing room. The mobile meat processing system can be used, in certain embodiments, to process bison. Also disclosed are various methods of processing animals into meat using the mobile meat processing system.

### CROSS-REFERENCE TO RELATED APPLICATION

This application claims the benefit under 35 U.S.C. § 119(e) to U.S. Provisional Application 62/534,492, filed Jul. 19, 2017 and entitled “Mobile Meat Processing System and Related Methods and Devices,” which is hereby incorporated herein by reference in its entirety.

### FIELD OF THE INVENTION

The present invention relates to a meat processing system, and more specifically to a mobile meat processing system.

### BACKGROUND OF THE INVENTION

As Americans and humans generally develop more sophisticated tastes for meat, free range bison has become a more popular option. As this interest has increased, there has been increased focus on humane treatment of bison as part of the process.

Unfortunately, for decades, known bison meat processing practices have involved handling of bison similar to the standard industrial model devised for cattle, including corralling and trucking of the bison, along with use of feedlots and industrial slaughter plants. While those processes and facilities are adequate and humane for cattle, bison are a different beast. The cattle feedlot model is too stressful for these nearly wild animals. Since bison have not been, and should not be, selected for docile natures that accept confinement, forcing them to endure the cattle model is tantamount to animal cruelty.

There is a need in the art for an improved system for harvesting or processing bison meat.

### BRIEF SUMMARY OF THE INVENTION

Discussed herein are various mobile meat processing units and systems for on-site meat processing and related methods.

In Example 1, a mobile meat processing system comprises a mobile unit, an animal processing room disposed within the mobile unit, a refrigeration room disposed within the mobile unit, and an animal intake door hingedly coupled along a bottom edge of the door to a wall of the animal processing room. The animal processing room comprises a spreader bar retractably coupled to a spreader bar winch attached to a ceiling of the processing room, and at least one processing rail attached to the ceiling of the processing room. The refrigeration room comprises at least two refrigeration rails attached to a ceiling of the refrigeration room, the at least two refrigeration rails being operably coupled to the at least one processing rail such that a carcass can be transported from the at least one processing rail to one of the at least two refrigeration rails. The intake door is configured to move between a closed position and an open position in which the intake door extends downward away from an outer wall of the mobile unit, whereby the intake door forms a ramp in the open position.

Example 2 relates to the mobile meat processing system according to Example 1, wherein the mobile unit is a wheeled trailer unit.

Example 3 relates to the mobile meat processing system according to Example 1, wherein the animal processing room further comprises a mobile cradle disposed therein.

Example 4 relates to the mobile meat processing system according to Example 1, further comprising a cooler door disposed between the animal processing room and the refrigeration room.

Example 5 relates to the mobile meat processing system according to Example 1, further comprising a mechanical room disposed within the mobile unit.

Example 6 relates to the mobile meat processing system according to Example 1, further comprising at least one intake winch disposed near the animal intake door.

Example 7 relates to the mobile meat processing system according to Example 1, further comprising a carcass offloading door disposed in another wall of the processing room.

Example 8 relates to the mobile meat processing system according to Example 7, wherein the at least processing rail extends to or near the carcass offloading door.

In Example 9, a mobile meat processing system comprises a mobile unit, an animal processing room disposed within the mobile unit, a refrigeration room disposed within the mobile unit adjacent to the animal processing room, a refrigeration door disposed between the animal processing room and the refrigeration room, a track system disposed from a ceiling of the mobile unit, and an animal intake door hingedly coupled along a bottom edge of the door to a wall of the animal processing room. The animal processing room comprises a spreader bar retractably coupled to a spreader bar winch attached to a ceiling of the processing room. The track system comprises at least one transport rail extending from the animal processing room into the refrigeration room through the refrigeration door, and at least two refrigeration rails disposed within the refrigeration room, the at least two refrigeration rails operably coupled to the at least one transport rail such that a carcass can be transported from the at least one transport rail to one of the at least two refrigeration rails. The intake door is configured to move between a closed position and an open position in which the intake door extends downward away from an outer wall of the mobile unit, whereby the intake door forms a ramp in the open position.

Example 10 relates to the mobile meat processing system according to Example 9, wherein the refrigeration door comprises two swinging doors.

Example 11 relates to the mobile meat processing system according to Example 9, wherein the animal processing room comprises a mobile cradle disposed therein, at least one sink disposed therein, at least one drain disposed on a floor of the animal processing room, and at least one basket disposed on a wall of the animal processing room.

Example 12 relates to the mobile meat processing system according to Example 9, further comprising an offal disposal door disposed along one external wall of the animal processing room, and a carcass offloading door disposed along another external wall of the animal processing room.

Example 13 relates to the mobile meat processing system according to Example 9, further comprising a mechanical room disposed within the mobile unit, wherein the mechanical room comprises at least one water tank disposed within the mechanical room, at least one water heater disposed within the mechanical room, and at least one controller disposed within the mechanical room.

Example 14 relates to the mobile meat processing system according to Example 9, further comprising first and second intake winches disposed near the animal intake door.

Example 15 relates to the mobile meat processing system according to Example 9, wherein the at least one transport rail extends from the refrigeration room to the carcass offloading door.

In Example 16, a method of processing meat in proximity with a living environment of target animals comprises stunning a target animal in the living environment of the target animal, hauling the target animal to a mobile harvesting unit with a stunning truck, urging the target animal into a processing room in the mobile harvesting unit, processing the target animal in the processing room into a harvested carcass, and transporting the harvested carcass from the processing room to a refrigeration room via a track system.

Example 17 relates to the method according to Example 16, wherein the target animal is a bison.

Example 18 relates to the method according to Example 16, wherein the urging the target animal into the processing room further comprises opening an animal intake door such that the intake door extends downward away from an outer wall of the mobile harvesting unit such that the intake door forms a ramp, urging the target animal up the ramp and through the animal intake door, and closing the animal intake door.

Example 19 relates to the method according to Example 16, wherein the processing the target animal in the processing room into the harvested carcass further comprises coupling the target animal to a spreader bar and raising the spreader bar toward a ceiling of the processing room via a spreader bar winch.

Example 20 relates to the method according to Example 16, further comprising transporting the mobile harvesting unit from the living environment to a processing plant and transporting the harvested carcass from the processing room out of a carcass offloading door via the track system.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1A is a perspective side view of an exterior of a mobile meat processing unit, according to one embodiment.

FIG. 1B is a side view of the exterior of the mobile meat processing unit of FIG. 1A.

FIG. 1C is a cross-sectional top view of the interior of the mobile meat processing unit of FIG. 1A.

FIG. 2A is a perspective view of an animal processing room, according to one embodiment.

FIG. 2B is a close-up view of one area of the animal processing room of FIG. 2A, according to one embodiment.

FIG. 2C is a side view of a spreader bar in use in the animal processing room of FIG. 2A, according to one embodiment.

FIG. 3 is a perspective view of a mobile cradle, according to one embodiment.

FIG. 4 is a perspective view of a splitting saw, according to one embodiment.

FIG. 5 is a perspective view of a winch on the ceiling of the animal processing room of FIG. 2A, according to one embodiment.

FIG. 6 is a perspective view of a carcass offloading door in the animal processing room of FIG. 2A, according to one embodiment.

FIG. 7 is a side view of a refrigeration room, according to one embodiment.

FIG. 8A is a side view of a stunning truck in use, according to one embodiment.

FIG. 8B is an expanded, perspective view of the hoist of the stunning truck of FIG. 8A in use, according to one embodiment.

FIG. 8C is an expanded, perspective view of the hoist of the stunning truck of FIG. 8A being positioned next to a mobile meat processing unit, according to one embodiment.

FIG. 9A is a side view of an animal being pulled up the ramp into a mobile meat processing unit, according to one embodiment.

FIG. 9B is a side view of the animal of FIG. 9A being loaded into the mobile meat processing unit, according to one embodiment.

### DETAILED DESCRIPTION

The various embodiments disclosed or contemplated herein relate to new methods and systems for bringing bison meat to market. Certain implementations include efficient, cost-effective, ecologically sound, and humane methods and systems that can replace the cattle feedlot model. Because buffalo are essentially wild animals, they suffer greatly when put through the crowding pens, squeeze chutes, close-quarters stunning, and bleeding that are standard procedures of industrial agriculture. The various bison meat harvesting embodiments disclosed herein are designed to alleviate that suffering. In fact, the suffering and stress caused to bison by the industrial cattle model can influence the taste of the bison meat such that the various implementations disclosed or contemplated herein can result in better tasting bison meat.

It is understood that the various embodiments disclosed or contemplated herein can be used for other types of animals as well, including cattle, etc.

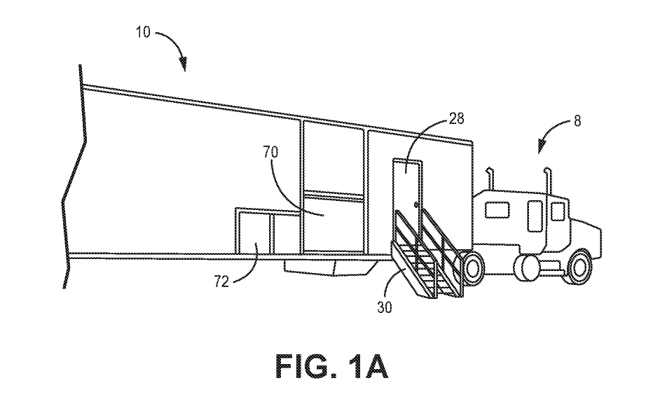

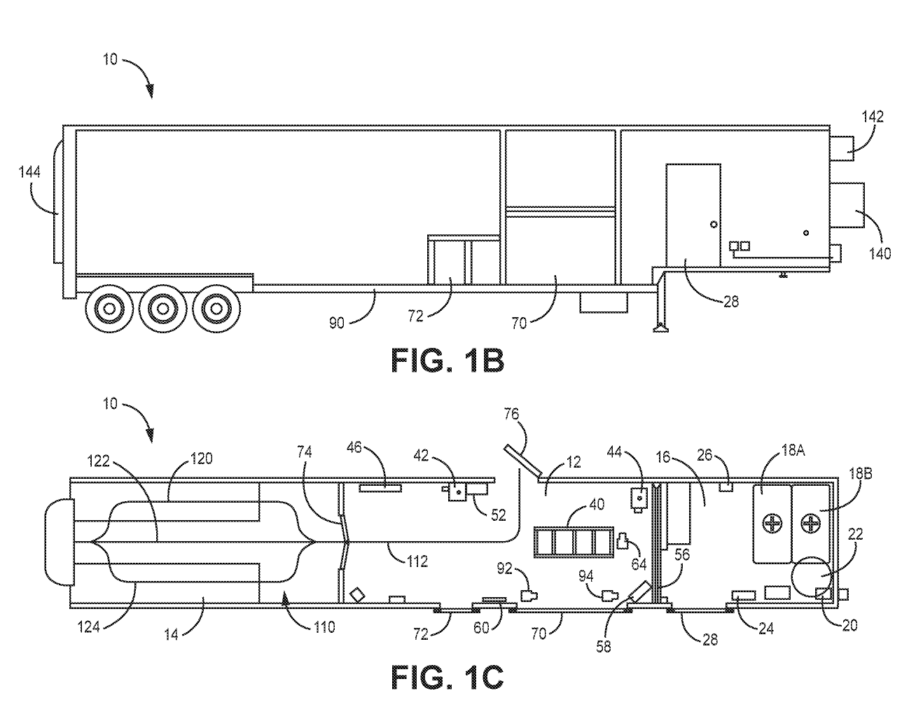

According to one embodiment as shown in FIGS. 1A-1C, a mobile meat processing unit (also referred to as a “harvest unit,” “harvest trailer,” or “processing trailer”) 10 can be used to harvest or process the bison meat. In this implementation, the mobile processing unit 10 is a trailer (such as a semitrailer) 10 that can be hitched to a tractor unit (such as the tractor 8 in FIG. 1A). As best shown in the floor plan of FIG. 1C, the trailer 10 has a processing room 12, a refrigeration room (or “cooler”) 14, and a mechanical room 16. Alternatively, the mobile unit 10 can be any known mobile structure (self-propelled or hauled by another motorized vehicle) that can have the features described herein and can be transported to an area near the target animals, as described in further detail elsewhere herein.

The mechanical room 16 includes at least one water tank 18 (in this specific example, there are two water tanks 18A, 18B), a water pump 20, a water heater 22, and a controller (also referred to as a “control panel”) 24 that is used to control such things as the air conditioners 142, 144 (discussed below), water pump 20, and other equipment on the trailer 10. In one embodiment as shown, a separate controller 26 is provided to control the generator 140 discussed below. Alternatively, one controller (such as controller 24, for example) can control all of the various pieces of equipment in the trailer 10. As best shown in both FIGS. 1B and 1C, an external door 28 provides access to the mechanical room 16, with deployable stairs 30 (as best shown in FIG. 1A) being positionable adjacent to or against the door 28. Alternatively, the mechanical room 16 can contain any known equipment, including any variation of the equipment disclosed or contemplated herein, useful for operation of the mobile unit 10 according to any embodiment herein.

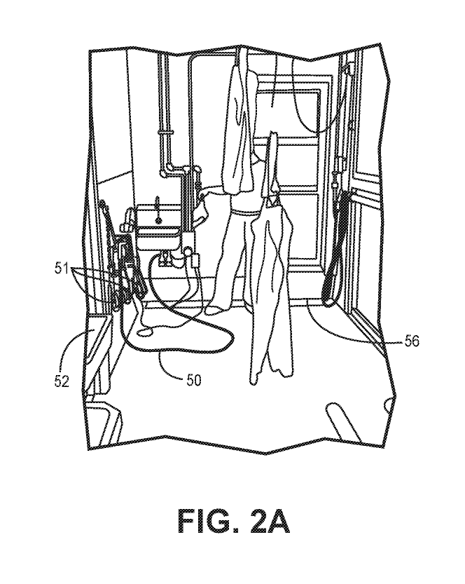

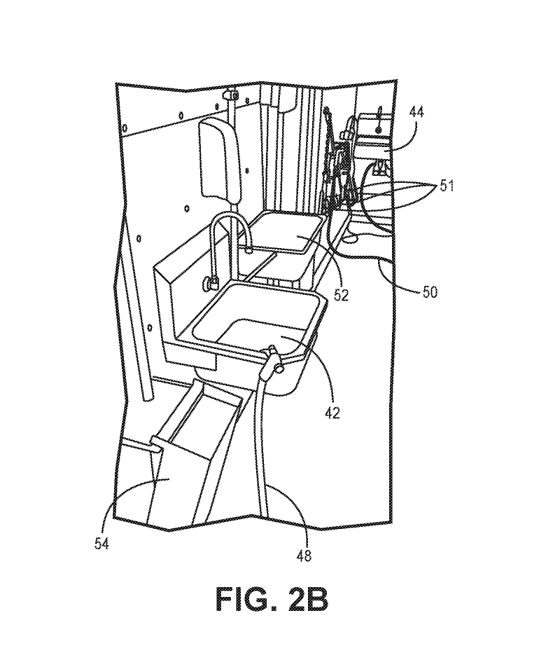

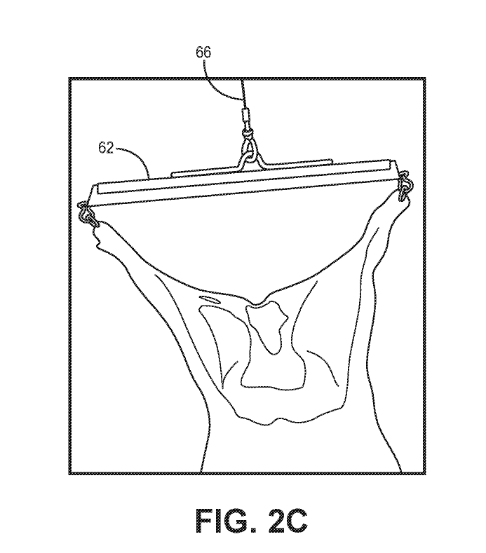

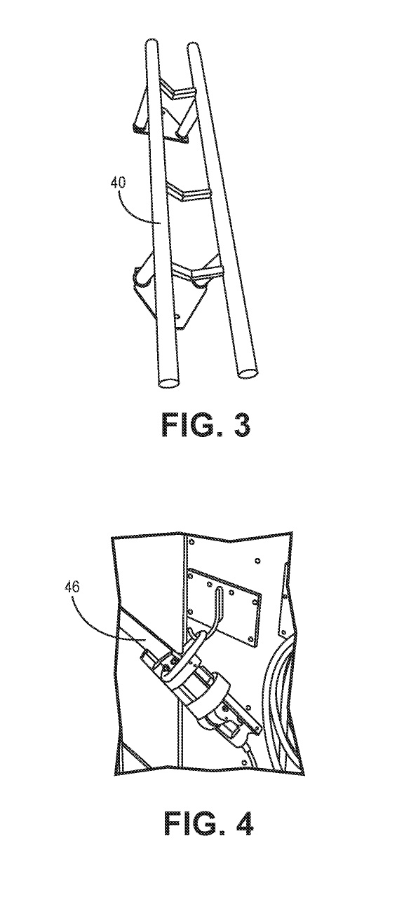

The processing room 12 is the space in which the animal is processed. For example, processing includes skinning and eviscerating the bison. In one specific implementation as best shown in FIGS. 1C, 2A, and 2B, the room 12 has a moveable processing cradle 40 (also depicted in FIG. 3), two wash sinks 42, 44 (both with knife sanitizers (not shown)), a splitting saw 46 (also shown in FIG. 4), two spray hoses 48, 50 (as best shown in FIGS. 2A and 2B), trolleys 51 (as best shown in FIGS. 2A and 2B) that can be rollably coupled to the track system 110 as discussed in detail below, a basket 52, and a waste disposal basket 54 (as best shown in FIG. 2B). According to one embodiment, the basket 52 is an organ basket 52 intended to retain organs harvested from the carcass for inspection. In addition, the room 12 includes a drain 56 (as best shown in FIGS. 1C and 2A) positioned at a low point in the floor that allows gray water (water used during the processing) to drain from the room 12. In the specific embodiment depicted in FIGS. 1C and 2A, the drain 56 is positioned at one end of the processing room 12 as shown. The room 12 can also have a heater 58 and a rack or other type of receptacle configured to receive the animal head (also referred to as a “head rack”) 60.

It is understood that the processing room 12 can contain any variation of known equipment for carcass and meat processing, including any variation of the equipment disclosed herein.

Further, as best shown in FIG. 2C, the processing room 12 has a spreader (also referred to as a “spreader bar,” “retention bar,” “hoisting bar,” or “processing bar”) 62 that is coupled to a winch 64 (depicted in FIG. 1C) coupled to the ceiling of the processing room 12 via a cable 66. As discussed in further detail below, the spreader bar 62 is attached to the hind legs of the animal so that the animal can be hoisted toward the ceiling via the cable 66 and winch 64 during processing.

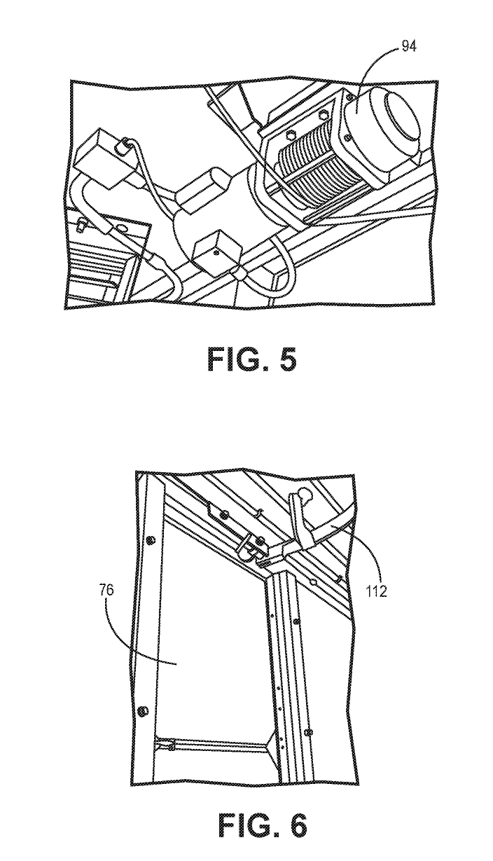

In addition, as best shown in FIGS. 1A-1C, there are four doors or access points 70, 72, 74, 76 to the processing room 12. The animal intake door 70 is an external door disposed along one external wall of the room 12. As will be discussed in further detail below, the intake door 70 is hingedly coupled at or near the base or floor 90 of the trailer 10 and opens outward (away from the trailer 10) such that the door 70 forms a ramp 70 that contacts the ground adjacent to the trailer 10 when it is open. In one implementation, two winches 92, 94 (one of which is also shown in FIG. 5) are provided that are coupled to the ceiling of the processing room 12 and disposed near or adjacent to the intake door 70. According to one embodiment as will be described in detail below, the winches 92, 94, along with appropriate cables, are used to help move the animal to be processed into the processing room 12.

The offal disposal door 72 is disposed next to the intake door 70 and allows individuals inside the processing room 12 to discard offal through the disposal door 72 during processing. The cooler door 74 is disposed between the processing room 12 and the refrigeration room 14 and provides access thereto. In one embodiment, the cooler door 74 is a set of two swinging doors 74. Alternatively, the cooler door 74 can be a set of two or more hanging plastic curtains 74 that hang from the ceiling and can be moved aside to move a carcass or a person through the curtains 74 from one room to the other. The carcass offloading door 76 is an external door 76 that allows for removal of the processed carcasses from the trailer 10.

It is understood that alternative embodiments of the trailer 10 can include versions having only one or two external doors (rather than three) providing access between the processing room 12 and the outside. In a further alternative, there can be four or more such external doors.

The processing room 12 also has at least one track or rail (also referred to as the “center rail” or “center track”) 112 that is part of a track system 110 coupled to the ceiling in the trailer 10, as discussed in further detail below. With respect to the rail 112 coupled to the ceiling in the processing room 12, the rail 112 extends from the offloading door 76 (as shown in FIG. 6) to the cooler door 74 as best shown in FIG. 1C such that a trolley 51 (or trolleys 51) coupled to a carcass (not shown) can be rolled along the rail 112. It is understood that the track 112 can have any configuration in the processing room 12 so long as the track 112 extends from the offloading door 76 to the cooler door 74.

The refrigeration room 14 is used to hold or store the processed carcasses prior to offloading the carcasses from the trailer 10. As such, the cooler 14 is maintained at a temperature ranging from about 30° F. to about 60° F. during use. Alternatively, the cooler 14 is maintained at a temperature ranging from about 30° F. to about 50° F. In further alternatives, the cooler 14 is maintained at a temperature ranging from about 30° F. to about 40° F. or from about 30° F. to about 32° F. It is understood, according to one exemplary implementation, that the air conditioning unit coupled to the refrigeration room 14 is set to a temperature of 30° F., and that the actual temperature in the room 14 can vary from 30° F. to any warmer temperature up to and even warmer than 60° F. for at least limited periods of time as a result of various factors, including the warmth radiated by the carcasses, the ambient temperature outside the trailer 10, etc. Much of the track system 110 mentioned above is disposed in the refrigeration room 14, as best shown in FIGS. 1C and 7. That is, the rail 112 discussed above extends from the processing room 12 through the cooler door 74 and into the refrigeration room 14 and is coupled to a set of rails 120, 122, 124 coupled to the ceiling in the refrigeration room 14. The rails 120, 122, 124 are coupled to the rail 112 and disposed adjacent to each other in the cooler room 14 such that multiple carcasses coupled to trolleys 51 can be transported from rail 112 to one of the rails 120, 122, 124 and thereby be hung from the rails 120, 122, 124 and thus disposed within the cooler 14, as will be described in further detail below. Alternatively, the track system 110 within the refrigeration room 14 can have any configuration that allows for hanging multiple carcasses within the refrigeration room 14.

As best shown in FIG. 1B, the trailer 10 also has a generator 140 that provides power to the various systems and devices on and in the trailer 10. In this specific embodiment, the generator 140 is disposed on an exterior wall of the trailer 10, in this case at the front end of the trailer 10. Alternatively, the generator 140 can be disposed anywhere on or in the trailer 10. In a further alternative, any known power source can be used, including, for example, an external source coupled to the trailer 10 via a power cord or other such connection. In addition, a first or general air conditioning unit 142 is provided that controls the temperature in the processing room 12. In this specific implementation, the air conditioning unit 142 is disposed on an exterior wall of the trailer 10, in this case at the front end of the trailer 10. Alternatively, the air conditioning unit 142 can be disposed anywhere on or in the trailer 10. Further, a second or refrigeration room air conditioning unit 144 is provided that controls the temperature in the refrigeration room 14. In this specific implementation, the air conditioning unit 144 is disposed on an exterior wall of the trailer 10, in this case at the rear end of the trailer 10. Alternatively, the air conditioning unit 144 can be disposed anywhere on or in the trailer 10.

In another embodiment, the trailer 10 can also have an external drain hose (not shown) extending under the trailer 10 from the drain 56 to some point or distance away from the trailer 10 to allow gray water from the animal processing to exit the drain 56 and be deposited away from the trailer 10. In a further implementation, a tank or other receptacle (not shown) can be coupled to or otherwise associated with the drain 56 to receive and collect the gray water.

As mentioned above, the mobile meat processing unit 10 is used as part of a humane system for harvesting bison meat. Alternatively, it can be used to process meat from any animal. As such, in use, the unit 10 can be incorporated into such a system in the following fashion.

In one implementation, the bison to be harvested are raised on a large landscape for winter and summer grazing. It is understood that buffalo evolved to move great distances over large landscapes and eat nothing but grass, sedges, and forbs. Hence, the ability to move miles each day and to have free range access to fresh, natural forage is very beneficial to their health and well being. As such, according to one embodiment, the field harvest process system contemplated herein includes first raising the animals in a large landscape that allows for movement of at least one mile per day. In certain implementations, the buffalo are not fed any supplemental grain—they are provided solely with the food that was historically available to them.

Prior to harvesting, the bison are preconditioned to be comfortable with the presence of the stunning truck 150, which is discussed in further detail below. That is, in certain implementations, a large vehicle, such as a truck, is driven or parked in the same landscape as the buffalo for certain predetermined periods of time so that the buffalo are comfortable with the presence of the vehicle. More specifically, according to certain embodiments, a regimen of training visits are scheduled in which a truck or other vehicle is placed in the presence of the buffalo herd. The truck is driven to move slowly at right angles to the herds and park quietly nearby to habituate the herds to gentle pickup traffic and thereby prepare them for the eventual introduction of the stunning truck 150. This creates the least stressful environment possible for the buffalo prior to the long-range stunning.

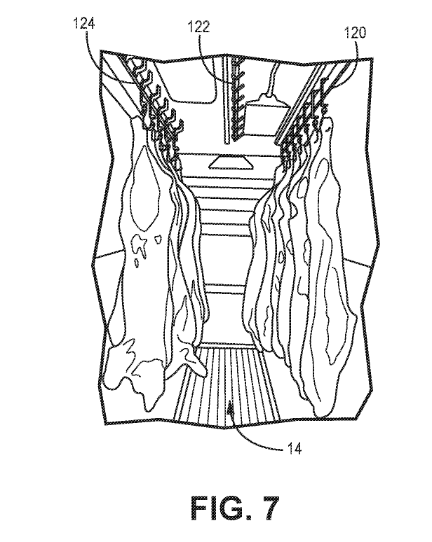

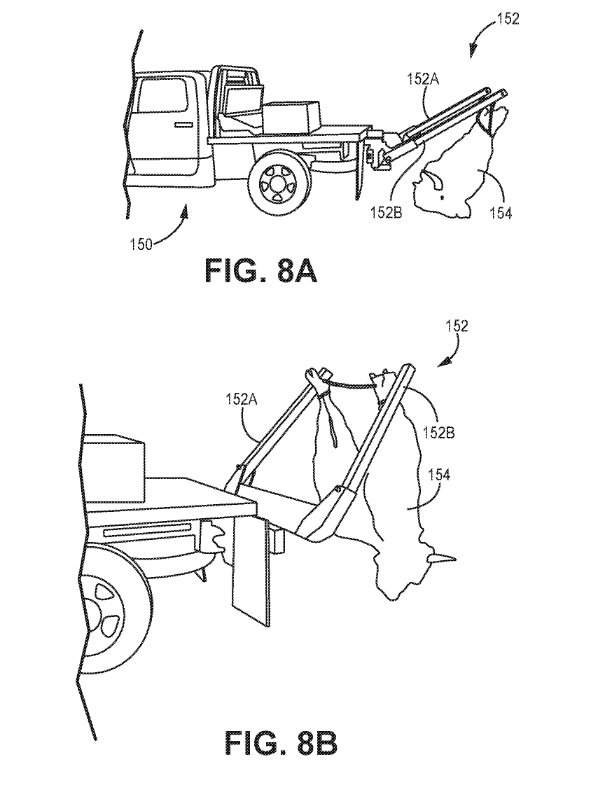

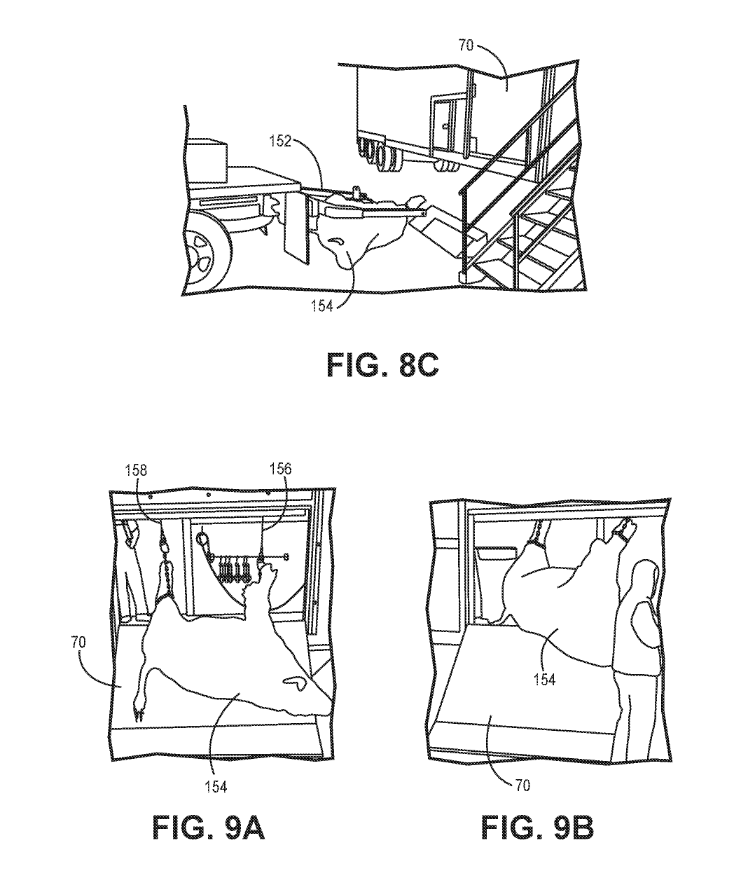

When it is time to harvest one or more buffalo, the stunning truck 150 as depicted in FIGS. 8A-8C is used. Alternatively, any known vehicle or method can be used to stun and/or transport the animal to the trailer. The truck 150 has an animal hoist 152 that can be used to retrieve the animal. In certain embodiments, the truck 150 can also be outfitted with one or more shooting rests (not shown) to facilitate accurate long-range stunning.

It is understood that the USDA Meat Inspection Act allows for buffalo to be stunned by a rifle (or a captive bolt apparatus). In one embodiment, the bullet and load used for the long-range stunning is a 30-06 caliber, hand loaded cartridge with 29 grains of 5744 powder and a 168 grain, all copper, Barrens bullet. This bullet and load are designed to stun the buffalo without passing through and endangering other buffalo in the herd. In accordance with one implementation, the bullet is fired at close range, usually within about 25 to about 50 yards of the animal. The shot, in one embodiment, is placed in one of two places: a front shot or a rear/side shot. The front shot can be placed in one exemplary embodiment at the junction of an imaginary line drawn from the left eye to the base of the right horn and one drawn from the right eye to the base of the left horn. The rear/side shot is, in another embodiment, a quartering, 45% rear to front shot, striking about an inch below and about an inch behind the visible ear. Alternatively, the stun shot is placed in any known location on the animal. In a further alternative, any other known stunning mechanism or method can be used.

Once the stunning shot is made and the animal is stunned, a known bleeding process follows immediately. Once the bleeding is completed, the stunning truck 150 is positioned in an appropriate position next to the bled buffalo 154 so that the buffalo can be coupled to and raised by the hydraulic animal hoist 152 as best shown in FIG. 8A. The hoist 152, in accordance with one embodiment, has a first bar 152A and a second bar 152B. The two bars 152A, 152B are positioned at a predetermined distance from each other that generally coincides with the distance between the front and back legs of a standard-sized target animal, such that the hoist 152 can be used to transport a target animal of any known size. Alternatively, the bars 152A, 152B can be any known distance apart. Once the animal 154 is raised to a height such that the animal 154 is no longer in contact with the ground (as best shown in FIG. 8B), the animal 154 is transported via the stunning truck 150 to the mobile unit 10, which is parked nearby.

As best shown in FIG. 8C, at the mobile unit 10, the bled buffalo 154 is lowered by the hoist 152 down to the ground next to the animal intake door 70 and uncoupled from the hoist 152. The intake door 70 is then opened and lowered as best shown in FIG. 9A to form a ramp 70. At this point, two cables 156, 158 are coupled to the front and rear legs, respectively, of the bled animal 154. The two cables 156, 158 are coupled at their other ends within the unit 10 to the two winches 92, 94 discussed above (not visible in FIGS. 9A and 9B). As such, the winches are now activated to begin to retract the cables 156, 158 into the unit 10, thereby urging the bled animal 154 up the ramp 70 and into the mobile unit 10 as best shown in FIGS. 9A and 9B. Once the animal 154 has been pulled into the unit 10, the door 70 is closed to minimize contamination of the unit 10 from the exterior surroundings.

Once the animal is inside the unit 10, the processing of the carcass proceeds in a fashion similar to known buffalo meat processing, according to one embodiment. In one implementation, the first step is to remove the buffalo's head and place it on the head rack 60, where it can be inspected by the USDA and/or state meat inspector per regulation. The carcass is then lowered onto the removable skinning cradle of FIGS. 1C and 3 so that it can be skinned. It is then coupled to the spreader 62 (as shown in FIG. 2C) and raised up for evisceration. The offal is then removed and expelled through the offal door 72.

At this point, according to one embodiment, the carcass is transferred to one of the meat trolleys 51 (as shown in FIG. 2A) that is rollably coupled to the overhead rail 112 and split into two halves and trimmed according to HACCP requirements, inspected, and marked with state or federal stamps. Once the inspection and stamping is done, in accordance with one implementation, the carcass is rolled via the meat trolley 51 along the rail 112 through the cooler doors 74 into the cooler 14 as best shown in FIG. 7.

This process can be repeated until the desired number of processed carcasses have been placed in the cooler 14. At this point, the unit 10 is transported to a processing plant for further processing of the carcasses.

Although the present invention has been described with reference to preferred embodiments, persons skilled in the art will recognize that changes may be made in form and detail without departing from the spirit and scope of the invention.

What is claimed is:

1. A mobile meat processing system comprising:
(a) a mobile unit;
(b) an animal processing room disposed within the mobile unit, the animal processing room comprising:
(i) a spreader bar retractably coupled to a spreader bar winch attached to a ceiling of the processing room; and
(ii) at least one processing rail attached to the ceiling of the processing room;
(c) a refrigeration room disposed within the mobile unit, the refrigeration room comprising at least two refrigeration rails attached to a ceiling of the refrigeration room, the at least two refrigeration rails being operably coupled to the at least one processing rail such that a carcass can be transported from the at least one processing rail to one of the at least two refrigeration rails; and
(d) an animal intake door hingedly coupled along a bottom edge of the door to a wall of the animal processing room, wherein the intake door is configured to move between a closed position and an open position in which the intake door extends downward away from an outer wall of the mobile unit, whereby the intake door forms a ramp in the open position.

2. The mobile meat processing system of claim 1, wherein the mobile unit is a wheeled trailer unit.

3. The mobile meat processing system of claim 1, wherein the animal processing room further comprises a mobile cradle disposed therein.

4. The mobile meat processing system of claim 1, further comprising a cooler door disposed between the animal processing room and the refrigeration room.

5. The mobile meat processing system of claim 1, further comprising a mechanical room disposed within the mobile unit.

6. The mobile meat processing system of claim 1, further comprising at least one intake winch disposed near the animal intake door.

7. The mobile meat processing system of claim 1, further comprising a carcass offloading door disposed in another wall of the processing room.

8. The mobile meat processing system of claim 7, wherein the at least processing rail extends to or near the carcass offloading door.

9. A mobile meat processing system comprising:
(a) a mobile unit;
(b) an animal processing room disposed within the mobile unit, the animal processing room comprising a spreader bar retractably coupled to a spreader bar winch attached to a ceiling of the processing room;
(c) a refrigeration room disposed within the mobile unit adjacent to the animal processing room;
(d) a refrigeration door disposed between the animal processing room and the refrigeration room;
(e) a track system disposed from a ceiling of the mobile unit, the track system comprising:
(i) at least one transport rail extending from the animal processing room into the refrigeration room through the refrigeration door; and
(ii) at least two refrigeration rails disposed within the refrigeration room, the at least two refrigeration rails operably coupled to the at least one transport rail such that a carcass can be transported from the at least one transport rail to one of the at least two refrigeration rails; and
(f) an animal intake door hingedly coupled along a bottom edge of the door to a wall of the animal processing room, wherein the intake door is configured to move between a closed position and an open position in which the intake door extends downward away from an outer wall of the mobile unit, whereby the intake door forms a ramp in the open position.

10. The mobile meat processing system of claim 9, wherein the refrigeration door comprises two swinging doors.

11. The mobile meat processing system of claim 9, wherein the animal processing room comprises:
(a) a mobile cradle disposed therein;
(b) at least one sink disposed therein;
(c) at least one drain disposed on a floor of the animal processing room; and
(d) at least one basket disposed on a wall of the animal processing room.

12. The mobile meat processing system of claim 9, further comprising:
(a) an offal disposal door disposed along one external wall of the animal processing room; and
(b) a carcass offloading door disposed along another external wall of the animal processing room.

13. The mobile meat processing system of claim 9, further comprising a mechanical room disposed within the mobile unit, wherein the mechanical room comprises:
(a) at least one water tank disposed within the mechanical room;
(b) at least one water heater disposed within the mechanical room; and
(c) at least one controller disposed within the mechanical room.

14. The mobile meat processing system of claim 9, further comprising first and second intake winches disposed near the animal intake door.

15. The mobile meat processing system of claim 9, wherein the at least one transport rail extends from the refrigeration room to the carcass offloading door.

16. A method of processing meat in proximity with a living environment of target animals, the method comprising:
stunning a target animal in the living environment of the target animal;
hauling the target animal to a mobile harvesting unit with a stunning truck;
urging the target animal into a processing room in the mobile harvesting unit;
processing the target animal in the processing room into a harvested carcass; and
transporting the harvested carcass from the processing room to a refrigeration room via a track system.

17. The method of claim 16, wherein the target animal is a bison.

18. The method of claim 16, wherein the urging the target animal into the processing room further comprises:
opening an animal intake door such that the intake door extends downward away from an outer wall of the mobile harvesting unit such that the intake door forms a ramp;
urging the target animal up the ramp and through the animal intake door; and
closing the animal intake door.

19. The method of claim 16, wherein the processing the target animal in the processing room into the harvested carcass further comprises coupling the target animal to a spreader bar and raising the spreader bar toward a ceiling of the processing room via a spreader bar winch.

20. The method of claim 16, further comprising:
transporting the mobile harvesting unit from the living environment to a processing plant; and
transporting the harvested carcass from the processing room out of a carcass offloading door via the track system.
